(19) United States
(12) Patent Application Publication
(10) Pub. No.: US 2018/0186107 A1
(43) Pub. Date: Jul. 5, 2018

(54) METHOD FOR MAKING A BODY WITH ARRANGED PARTICLES USING ACOUSTIC WAVES

(71) Applicant: PROXONIX AS, Oslo (NO)

(72) Inventor: Mark BUCHANAN, Oslo (NO)

(21) Appl. No.: 15/737,518

(22) PCT Filed: Jun. 17, 2016
(86) PCT No.: PCT/NO2016/000019

§ 371 Date: Dec. 18, 2017

(30) Foreign Application Priority Data
Jun. 22, 2015 (NO) 20150824

(51) Int. Cl. B29C 70/62; B29C 70/26; B29C 70/66; B29D 7/01; C08J 5/18

(52) U.S. Cl. CPC B29C 70/62; B29C 70/26; B06B 1/06; B29D 7/01; C08J 5/18; B29C 70/66

(57) ABSTRACT

The present disclosure relates to a method for manufacturing a body comprising a particle structure fixated in a matrix material, said method comprising the steps of: providing a mixture of a viscous matrix material and particles, subjecting said particles to an acoustic standing wave, so as to arrange at least portion of said particles in a pressure node and/or a pressure antinode of the acoustic standing wave thereby creating a particle structure In said viscous matrix material and fixating said viscous matrix material so as to fixate said particle structure In said matrix material. The disclosure also relates to a body obtained by said method, and to the use of said method in various applications.

### TECHNICAL FIELD

The present disclosure relates to a method for manufacturing a body, such as a film, comprising a particle structure fixated in a matrix material, said method comprising the steps of:
providing a mixture of a viscous matrix material and particles,
subjecting said particles to an acoustic standing wave, so as to arrange at least portion of said particles in a pressure node and/or a pressure antinode of the acoustic standing wave thereby creating a particle structure in said viscous matrix material, and
fixating said viscous matrix material so as in fixate said particle structure in said matrix material.

The disclosure also relates to a body obtained by said method, and to the use of said method in various applications.

### BACKGROUND

Consumers' needs and industrial trends prompt the development of materials in many diverse fields such as sensor technology, 3D printing, printed electronics, food packaging and technical textiles. There has been a dramatic increase and development in all of these fields leading to major improvements. For instance, the introduction of active and intelligent food packaging can extend the shelf life of food or improve its organoleptic properties and thus prevent food losses. In a further example, technical textiles provide benefits in a large number of applications. Technical textiles are a large and growing sector directed to textiles manufactured for non-aesthetic purposes, where function is the primary criterion. Technical textiles include textiles for automotive applications, medical textiles (e.g., implants), geotextiles (reinforcement of embankments), agrotextiles (textiles for crop protection), and protective clothing (e.g., heat and radiation protection for fire fighter clothing, molten metal protection for welders, stab protection and bulletproof vests, and spacesuits).

Frequently, the desired material properties are imparted by particles included in the materials produced for a particular application. However, the location of the particles within the material is also critical for the overall material performance.

For instance, anisotropic materials are used in a wide and increasing range of applications. Typically, such materials include conductive particles fixated in a non-conductive matrix material. The conductive particles are intended to form conductive materials in the matrix material, so as to enable the anisotropic material to be, at least under certain circumstances, electrically conductive. Depending on the selection of particles and matrix materials, the anisotropic materials may be formed to be suitable for various applications, such as sensors, in solar cell applications, in printed electronics etc.

WO2014/001334 discloses a method for forming a body comprising a particle structure fixated in a matrix material. The particles are arranged in the matrix material as a result of being subjected to an electric and a magnetic field.

Despite their usefulness, methods relying on the use of electric and/or magnetic fields are limited to particles susceptible thereto. Further, the particle structure will be determined by the electric and/or magnetic field direction.

In some applications, the particles may include or consist of non-metallic particles thereby necessitating methods allowing for movement of these particles into a desired location within the material being formed. Examples of such particles include non-metallic oxygen scavengers, such as ascorbic acid, in food packaging, and silica particles in technical textiles. Coating technology is sometimes an option, but it is not always suitable or appropriate.

Acoustophoresis means migration with sound, wherein sound waves are the executors of movement. Particles in suspension exposed to an acoustic standing wave field will be affected by a radiation force. The force will cause the particles to move in the sound field if the acoustic properties of the particles differ from that of the surrounding medium. The magnitude of the particle movement and the particle movement direction will be determined by factors such as particle size, acoustic pressure amplitude, frequency of the sound wave etc.

Acoustophoresis has been used for separation purposes. U.S. Pat. No. 5,147,562 discloses an acoustophoresis method and apparatus for separation of species. It is mentioned that the acoustophoresis concept can utilize bulk congressional waves, surface waves or boundary waves between a solid (or liquid) container wall and a liquid subject. Acoustophoresis has also been used in the context of Lab on a Chip, i.e. on vary small scale, for biological applications. In Lab Chip, 2012, 2766-2770, it is described how Surface Acoustic Wave (SAW) acoustophoresis may be used for micro-object manipulation.

Mitri, F. G., Sinha, D. N. (IEEE, International Ultrasonics Symposium Proceedings, Pages 1556-1558, 2011) describe a method for making a repeating periodic 3D structure using ultrasound methods. This method is a fabrication technique. However, unlike the invention presented here this technique makes a material in a small cavity of 12 mm times 12 mm times 44 mm rather than a large film prepared by roll-to-roll or extrusion processes.

Manipulation of particles in fluid channels, such as “Lab on a Chip” devices, has also utilized acoustophoresis techniques to separate out a variety of materials. Lin et. al. (Surface acoustic wave acoustophoresis: now and beyond, Lab Chip., 2012 Aug. 21, pp 2766-70 and Wood et al. Alignment of particles in microfluidic systems using standing surface acoustic waves, Applied Physics letters; Jan. 1, 2008, Vol 92, Issue 4, p 044104 describe acoustic methods in a “Lab on a Chip” device. Such a device is quite different from the Roll-to-roll manufacturing/process technology application described here.

Thus, there is a need for alternative methods for forming materials such as functional materials allowing for increasing the versatility of the materials formed, and to enable industrial production thereof.

It is an object of the present disclosure to provide a method fulfilling said need

### SUMMARY

The above-mentioned object is achieved by a method for manufacturing a body comprising a particle structure fixated in a matrix material, said method comprising the steps of:
providing a mixture of a viscous matrix material and particles,
subjecting said particles to an acoustic standing wave, so as to arrange at least portion of said particles in a pressure node and/or a pressure antinode of the acoustic standing wave thereby creating a particle structure in said viscous matrix material, and
fixating said viscous matrix material so as to fixate said particle structure in said matrix material.

As used herein, “particle structure” is meant any desired configuration or structure of particles which is or is to be fixated in the matrix material.

As used herein “fixate” and “fixation” refers to make fixed, stationary, or unchanging. Fixation of the matrix material may be achieved by any suitable method, such as, for example, curing, ceramisation, cross-linking, gelling, irradiating, drying, heating, sintering or firing.

As used herein, “film” or “sheet” is meant any desired configuration or structure of the matrix material, for example made of ceramic, metallic, polymeric and/or biomolecular materials preferably width: 0.01-100 m: thickness: 0.01-10 mm, Length: 0.0001-100 km.

The acoustic wave may be provided between a first support and a second support contacting the mixture of viscous material and particles. Thus, there is provided a method as described herein further comprising a step of:
contacting said mixture with a first support and a second support.

The first support and/or the second support may independently be made of a material comprising or consisting of steel, silicon, glass or any other suitable material. The first support and second support may be arranged to be located opposite to each other.

An acoustic wave may also be provided between further supports, said further supports contacting the mixture of viscous material and particles. The further supports, such as a third support and a fourth support, may be arranged to be opposite to each other and/or perpendicular to said first and second supports.

The acoustic standing wave may be provided by an acoustic resonator as known in the art. For instance, the acoustic resonator may be an ultrasonic transducer. The acoustic wave pressure amplitude and frequency may be adjusted to achieve the desired particle movement. The acoustic standing wave will provide one or more pressure node(s) and one or more pressure antinode(s). In the method described herein, a pressure node may be formed at an interface between the mixture of viscous matrix material and particles, and the first support and/or second support. Additionally or alternatively, a pressure node may be formed within the mixture of viscous matrix material and particles. Similarly, a pressure antinode may be formed at an interface between the mixture of viscous matrix material and particles, and the first support and/or second support. An antinode may also be formed within the mixture of viscous matrix material and particles. As an example, pressure nodes may be formed at the interface between the mixture and the first support, between the interface between the mixture and the second support and optionally within the mixture. Additionally, one or more pressure antinodes may be formed within the mixture. In a further example, pressure antinodes may be formed at the interface between the mixture and the first support, between the interface between the mixture and the second support and optionally within the mixture. Additionally, one or more pressure nodes may be formed within the mixture.

It will be appreciated that in the method described herein, the acoustic standing wave may be applied in one or more steps using acoustic standing waves of different magnitudes.

Depending on the particle properties such as size and aggregation state, the particles may gather at pressure nodes and/or pressure antinodes of the acoustic standing wave. For instance, large and/or rigid particles may gather at nodes while liquid particles may gather at antinodes. Time may also influence the result, making both small and large particles gather at nodes as time evolves.

The particles of the mixture of the method described herein may be one kind of particles or a mixture of different kinds of particles. The particles may be metallic, i.e. comprise or consist of a metal, or non-metallic. Examples of non-metallic particles include particles comprising or consisting of ceramic materials, polymers, oils, gases etc. Further, the particles may be conductive particles or non-conductive particles. In still a further example, the particles may be displaceable by a magnetic field such as paramagnetic particles or ferromagnetic particles.

The particles of the mixture of the method described herein may be selected from the group consisting of metal particles, air bubbles, oil droplets, polymer particles, carbonaceous particles, ceramic particles, bioactive particles, bacteria, viruses, archaea, fungi, sand particles, glass particles, colloidal particles and any combinations thereof.

The particles may be homogenous particles, i.e. a particle consists of a single material or a material mixture throughout the particle. However, the particles may also be heterogeneous particles, i.e. a particle consists of several materials. For example, the particle may have a core of one material, and a sheath of another material.

The particles may have any suitable shape. For instance, the particles may be substantially spherical or have an elongate shape.

Depending on the application, the particle size and/or size distribution may vary. As used herein, the particle size is understood to mean the largest linear dimension of the particle. As an example, the particles may have substantially the same size and/or density. The particle size may be in the micrometer or nanometer range. For instance, the particle size may be within the range of from 10 nm to 100 μm. Additionally or alternatively, the particles may have different sizes and/or densities. Further, the specific application will determine the appropriate concentration of particles to be used. If conductive particles are used in the method described herein, the concentration of these particles may be below a percolation threshold.

As used herein, a percolation threshold is defined as the lowest concentration of conductive particles necessary to achieve long-range conductivity in a random system. Such a random system is nearly isotropic.

The matrix material should be a material having a viscous form which is capable of being fixed. Fixation may be achieved by any suitable methods such as, for example, curing, cooling, ceramisation, cross-linking, gelling, irradiating, drying, heating, sintering, or firing. As an example, fixating the viscous matrix material may take place by curing.

The viscous matrix material may comprise or consist of a polymer. Fixating such as curing may then involve cross-linking of the polymer. The viscous matrix material may be UV-curable, and fixating of the viscous matrix material may comprise UV-curing thereof. Additionally or alternatively, the viscous matrix material may undergo humidity-curing, and fixating of the viscous material may comprise exposure of the mixture described herein to moisture, such as in air and at room temperature.

Prior to fixating of the viscous material, the method described herein may comprise one or more additional steps comprising subjecting the mixture of viscous matrix material and particles to an electric field and/or a magnetic field. The mixture may be subjected to the electric field and/or magnetic field before, after and/or at the same time as the mixture is subjected to the acoustic standing wave. In this way, different kinds of particles may be moved to different parts of the material being formed. For instance, conductive particles may be aligned along the flux direction along an electric field while non-conductive particles may gather at nodes and/or antinodes of the acoustic standing wave. In a further example, ferromagnetic particles are aligned along a flux direction along a magnetic field while non-magnetic particles gather at nodes and/or antinodes of the acoustic standing wave.

Once the viscous matrix material has been fixated, it may be desired to remove the first support and/or the second support. Thus, the method described herein may comprise a step of removal of said first support and/or said second support. The removal may take place by e.g. tearing, etching or dissolution of the support with a solvent. Upon removal of the first support and/or the second support at least part of the particle structure at the interface between the first and/or second support and the mixture of viscous matrix material and particles may become exposed. Additionally or alternatively, at least part of the particle structure may be embedded within the fixated matrix material so that it is not exposed, or exposed to a very limited extent, upon removal of the first support and/or the second support.

The matrix material may be a cross-linked polymer material upon fixation. This enables creation of bodies being useful for applications where the polymer properties of the matrix material is used together with the properties with the particle structure to achieve a desired function.

The body formed in the method described herein may have any suitable shape. For instance, it may have the shape of a film. In a further example, the body may have the shape of a layer, a combination of layers, a coil, a ball etc.

The body formed in the method described herein, may be used in combination with bodies formed by other methods. For instance, the body formed in the method described herein may be a layer, said layer being combined with layers formed by other methods.

Advantageously, the method described herein may be used in combination with well-known industrial methods. For instance, the industrial method may be adapted to include the method described herein. For instance, the method described herein may be used in combination with roll-to-roll processing, extrusion processes, 3D printing, electric and/magnetic fields, optical trapping and manipulation and/or printed electronics technology.

It will be appreciated that the method described herein may in itself be used on an industrial scale. This is a significant advantage, since it allows for large scale production of various kinds of materials as described herein.

The present disclosure also provides a body comprising a particle structure fixated in a matrix material, wherein said body is obtainable by the method described herein. There is also provided an article comprising said body is obtainable by the method described herein. The article may be selected form the group consisting of packaging materials, printed electronics, laminated materials, textiles such as technical textiles, paper and containers.

There is also provided a use of the method described herein for creating packaging materials such as food packaging materials.

There is also provided a use of the method described herein for creating printed electronics.

There is also provided a use of the method described herein for creating laminated materials.

There is also provided a use of the method described herein for creating textiles such as technical textiles.

There is also provided a use of the method described herein for creating paper.

There is also provided a use of the method described herein for creating containers.

### BRIEF DESCRIPTION OF THE DRAWINGS

The disclosure will now be further illustrated with reference to exemplary embodiments, with reference to the enclosed drawings, wherein:

FIG. 1 shows a structure comprising a first support 1 and a second support 2 between which a mixture of particles 3 and a viscous matrix material 4 is located.

FIG. 2 shows the structure of FIG. 1 subjected to an acoustic standing wave providing nodes 5 and antinodes 6. The particles gather in the nodes 5 and antinodes 6.

FIG. 3a shows the structure of FIG. 1 after having been subjected to an acoustic wave in such a way that the particles are pushed to a surface of the film being produced.

FIG. 3b shows the structure of FIG. 3a after fixating of the viscous matrix material followed by removal of the first support 1.

FIG. 4 shows the structure of FIG. 1 after having been subjected to an acoustic standing wave in such a way that the particles are pushed to a mid-point of the film being produced, followed by fixating of the viscous matrix material 4 and removal of the first support 1.

FIG. 5 shows production of new materials, such as tapes or films.

FIG. 6 shows how the process images are taken.

FIG. 7 shows AFS process in a glass plate flow cell with a fluid channel in between.

FIGS. 8a,b,c shows the AFS process used on micro organisms.

FIG. 8a: F=0 Hz

FIG. 8b: F=1950 kHz

FIG. 8c: F=5770 kHz

FIG. 9: 4.5 μm polystyrene beads low concentration when applying the acoustic force.

FIG. 9A: Applied AF, 2 nodes

FIG. 9B: Particles clustering

FIG. 9C: Frequency change moves particles to new plane.

FIG. 10: Increased concentration by 100 fold with 4.5 μm beads.

FIG. 11: A sweep over a large range of frequencies that is applied.

FIG. 11A: Force off (T=0)

FIG. 11B: Force on (T=1)

FIG. 11C: Force on (T=2)

FIG. 11D: Force on (T=3)

FIG. 12: Acoustic affects with smaller 2.1 μm polystyrene beads.

FIG. 13: When the force is turned on kaolin is pushed on the acoustic node and overtime the Kaolin clusters together.

FIG. 13A: Force off

FIG. 13B: Force on

FIG. 14: The effect on the viscosity was studied by measuring the velocity of the bead when responding to acoustic force.

FIG. 15: Measured force response when viscosity is increased: 0, 10, 20 and 30% of glycerol was used to increase the viscosity and measure the effect on the force amplitude.

It should be noted that the drawings have not been drawn to scale and that the dimensions of certain features have been exaggerated for the sake of clarity.

### DEFINITIONS

Nanometer is abbreviated nm.

Micrometer is abbreviated μm.

Node is used interchangeably with pressure node.

Antinode is used interchangeably with pressure antinode.

AFS is used as abbreviation for “acoustophoresis”.

### DETAILED DESCRIPTION OF EMBODIMENTS

The device for preparing an anisotropic and/or inhomogeneous polymer film using an acoustic wave may be referred to as an acoustic force applicator (piezo). The acoustic is force applicator may be utilized for this method in a continuous process. In one or more embodiments, a continuous process may include a roll to roll process, where a roll of polymer film is provided, the polymer film is unrolled and moved through the acoustic field application zone to induce orientation in the polymer film, and rerolled on a take-up roll down line from the acoustic field application zone. In some embodiments, a continuous process may be provided where the polymer film is prepared, for example by polymer film casting on one end of the acoustic field generator, the polymer film is then moved through the acoustic field application zone to induce structures in the polymer film, and rolled on take-up roll down line from the acoustic field application zone.

Suitable polymers that may be used to create anisotropic polymer films include UV curable polymers, thermally curable polymers, and polymers in solution. The polymers may be heteropolymers or copolymers.

In one or more embodiments, the polymer film may include a block copolymer. In one or embodiments, the block copolymer may be a di-block copolymer represented by the formula: A-B, where A represents a block of repeating units and B represents a second different block of repeating units. In one or embodiments, the block copolymer may be a tri-block copolymer represented by the formula: A-B-A or A-B-C, where A represents a block of repeating units, B represents a second different block of repeating units, and C represents a third different block of repeating units. In one or embodiments, the block copolymer may be a tetra-block copolymer represented by the formula: A-B-A-B, A-B-C-A, A-B-C-B, or A-B-C-D, where A represents a block of repeating units, B represents a second different block of repeating units, and C represents a third different block of repeating units, and D represents a fourth different block of repeating units.

In embodiment that use a polymer in solution useful solvents for dissolving the polymer include, N-methyl pyrrolidine (NMP), dimethylformamide (DMF). dimethylsulfide (DMS), dimethylsulfoxide (DMSO), dimethyl acetamide (DMAC), cyclohexane, pentane, cyclohexanone, acetone, methylene chloride, carbon to tetrachloride, ethylene dichloride, chloroform, ethanol, isopropyl alcohol (IPA), butanols, THF, MEK, MIBK, toluene, heptane, hexane, 1-pentanol, water, or suitable mixtures of two or more thereof. The solvents can be both aqueous or non-aqueous.

In one or more embodiments, the concentration of polymer in solvent in the polymer solution is from about 5 weight percent to about 50 weight percent, in other embodiments from about 10 weight percent to about 45 weight percent, in other embodiments from about 15 weight percent to about 40 weight percent, in other embodiments from about 20 weight percent to about 35 weight percent, in still other embodiments from about 25 weight percent to about 30 weight percent.

As noted above, the polymer film may include particles. Suitable particle for use in preparing anisotropic polymer films include conducting particles semiconducting particles or dielectric particles. It should be noted, that in certain embodiment, particularly where a semi-conducting or conducting particle is used, an insulating layer may be required between the polymer film and the electrodes.

Suitable conductive particles may be prepared from Co, Ni, CoPt, FePt, FeCo. Fe3O4, Fe2O3, and CoFe2O4. Suitable semiconductive particles may be prepared from ZnS, CdSe, CdS, CdTe, ZnO, Si, Go, GaN, GaP, GaAS, InP, and InAs. Additional particles that may be conductive or semiconductive include carbon based nanoparticles, carbon black, carbon nanotubes (single as well as multi-walled) as well as other inorganic and organic synthetic or natural nanoparticles.

In some of the various embodiments, the size of the particles are in the range of about 0.1 nm to about 500 micrometres. In some of the various embodiments, the body has the shape of a film with width in the range of: 0.01-100 m, preferably 0.1 to 10 m, thickness 0.01-10 mm, preferable 0.1 to 1 mm and length: 0.0001-100 km, preferable above 1 m. In a roll to roll production of film, the film could be continuous and as such have an indefinite length.

The embodiments are further illustrated by the figures discussed below:

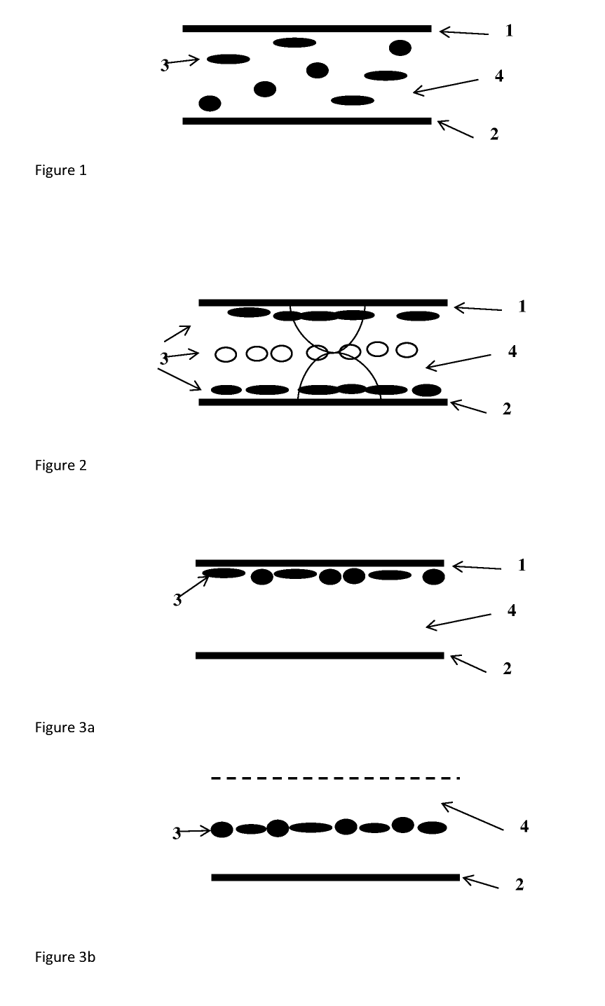

FIG. 1 shows a structure comprising first support 1 and a second support 2 between which a mixture of particles 3 and a viscous matrix material 4 is located. The particles comprise substantially spherical particles and elongate particles. The first support 1, the second support 2, the particles 3 and the viscous matrix material 4 may be as described elsewhere in this document. The structure has not yet been subjected to an acoustic standing wave, and it can be seen that the particles are randomly distributed within the viscous matrix material.

FIG. 2 shows the structure of FIG. 1 subjected to an acoustic standing wave providing nodes 5 and antinodes 6. The spherical particles gather in the nodes 5. The elongate particles gather in the antinodes. This illustrates the fact that the particles with different properties, such as different shapes, will be differently affected by the acoustic wave and therefore move to different locations.

FIG. 3a shows the structure of FIG. 1 after having been subjected to an acoustic wave in such a way that the particles are pushed to a surface of the film being produced.

FIG. 3b shows the structure of FIG. 3a after fixating of the viscous matrix material followed by removal of the first support 1. As can be seen, removal of the first support leads to exposure of the particles 3.

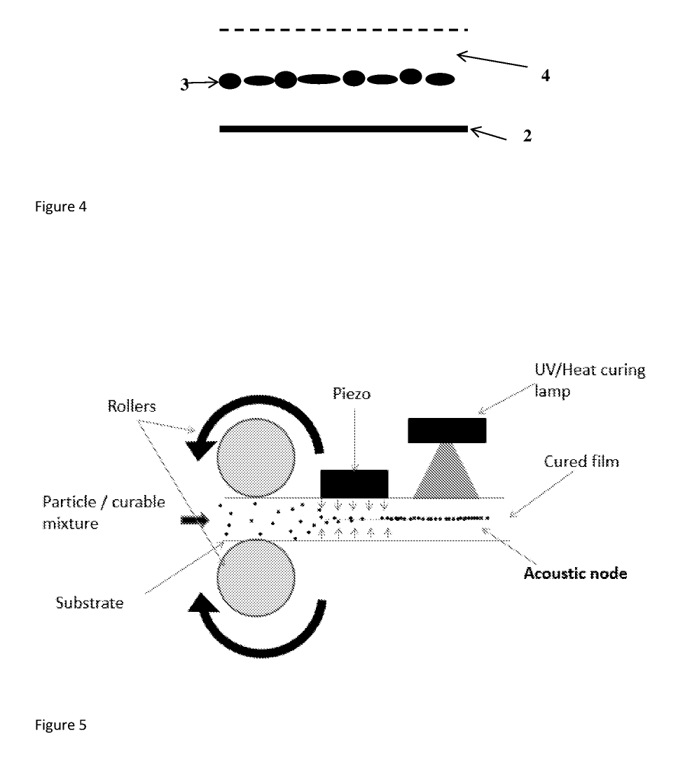

FIG. 4 shows the structure of FIG. 1 after having been subjected to an acoustic standing wave in such a way that the particles are pushed to a mid-point of the film being produced, followed by fixating of the viscous material 4 and removal of the first support 1. As can be seen, in this case removal of the first support does not expose the particles 1.

FIG. 5 shows how the wanted material out pushed in the acoustic node to make industrial tapes or films A mixture of particles and curable solvent are guided to a piezo device that is in contact with the film. The piezo applies the acoustic wave (AFS) that positions the particles in the mixture in the acoustic node. This is followed by a curing stage (e.g. UV or heat curing) that sets the film. The substrates can subsequently be removed if required.

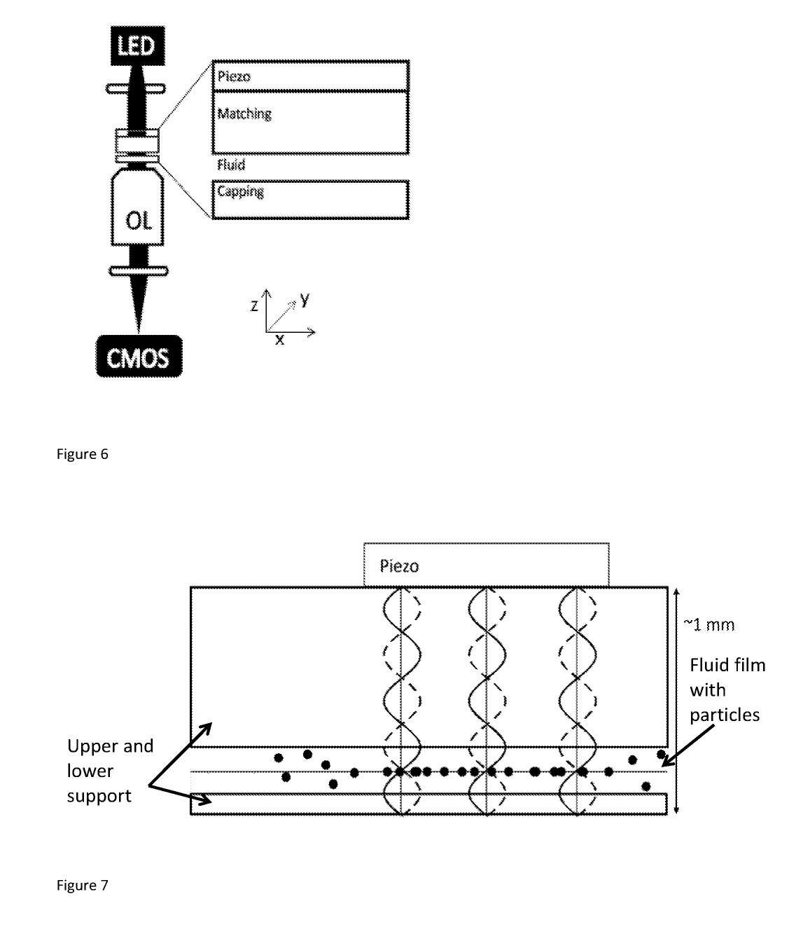

FIG. 6 shows bow images of the AFS process are taken:

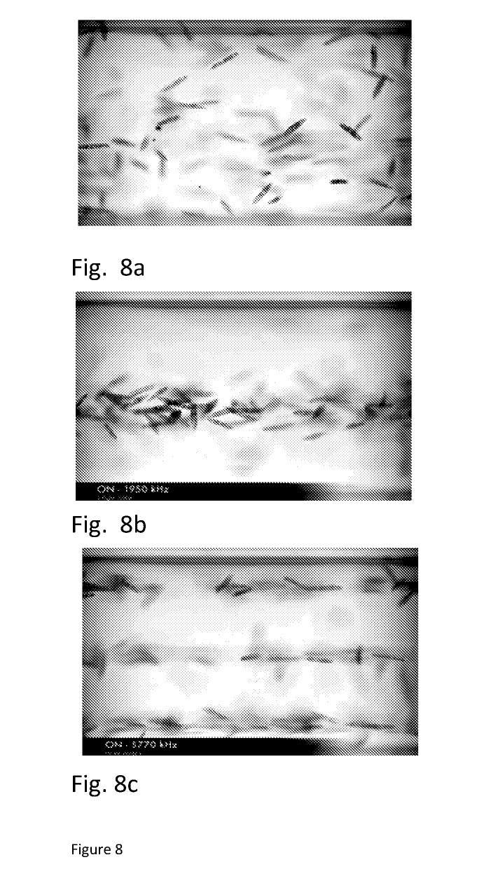

Imaging of AFS process in film. An inverted microscope is used to image the system. Changes in height can be observed by the change in the diffraction pattern of the particle. The images in FIG. 8-13 were taken using this technique. Principle of Acoustic Force Spectroscopy, (a) The experimental setup consists of the Acoustic Force Spectroscopy device integrated in a flow cell. The optics used for imaging are: an inverted microscope to equipped with a microscope objective lens (OL), a digital camera (CMOS), a LED light source (455 nm) and a 60/50 beam splitter (BS). (b) The flow cell consists of two glass plates with a fluid chamber in between. For illumination purposes, the upper glass slide has a sputtered mirroring aluminum layer on top. A piezo plate is glued on fop of the mirror. Similar to the flow cell, a film can be viewed.

FIG. 7 shows an AFS process in a glass plate flow cell with a fluid channel in between. The acoustic wave is created by the piezo element. A standing wave is created by bringing the system in resonance. Microspheres that are flushed in the fluid layer are pushed toward the node of the acoustic standing wave. These can be imaged using inverted microscopy (FIG. 6). Similar to the flow cell, a film can be viewed.

FIGS. 8a, b, c shows how the AFS process is used on micro-organisms. The frequencies (F) were FIG. 8a: F=0 Hz , FIG. 8b: F=1950 kHz and FIG. 8c: F=5770 kHz. The fluid channel is shown from the side.

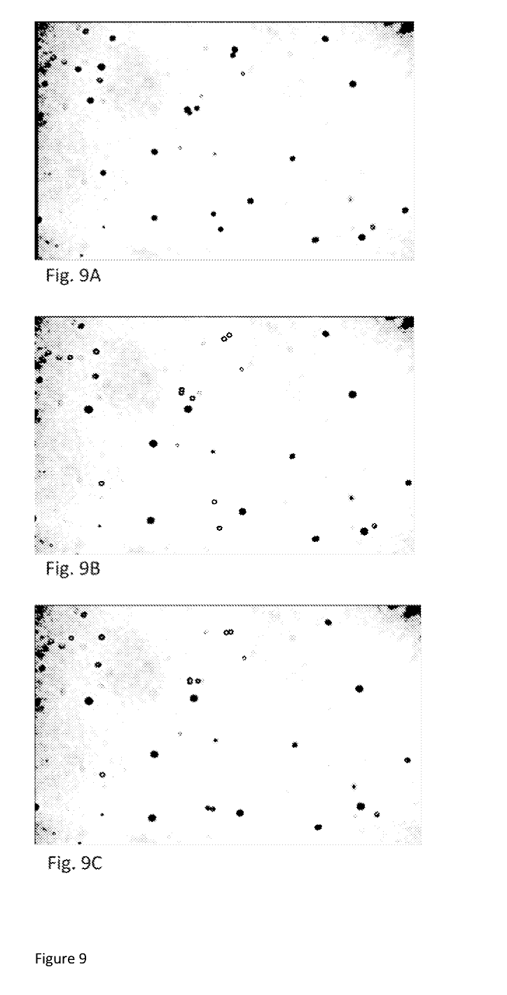

FIG. 9: 4.5 μm polystyrene beads (0.01-0.1 vol %) low concentration. (A) When applying the acoustic force, beads are pushed in two nodes, as expected from this system. (B) Beads are also attracted by each other. If beads are close enough they cluster together. (C) When a different resonance frequency is applied the beads are pushed to another plane.

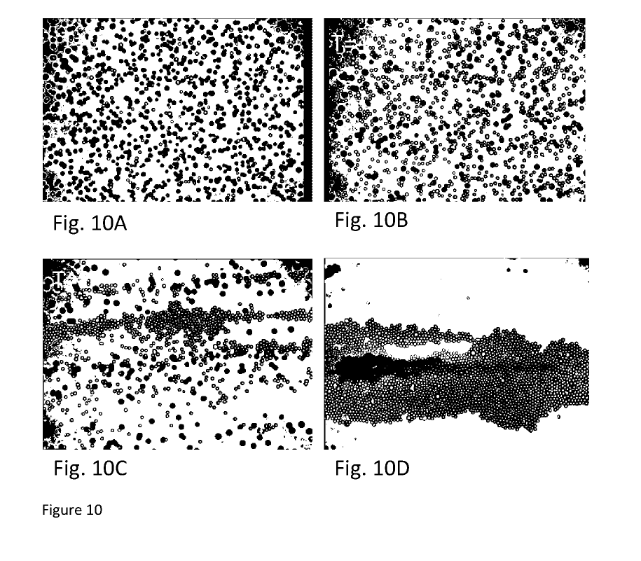

FIG. 10: increasing the concentration (1-10%) to by a 100 fold 4.5 μm bead. (A) Force off. (B) Force on. (C) Force on, (D) Force on, different field of view. By increasing the concentration, beads are still pushed in to the node of the acoustic wave. Stronger bead to bead interaction is visible because the beads are closer to each other. Here longitudinal nodes are also visible, because of a resonance over the width of the flow channel By increasing the amplitude of the acoustic wave, beads are more clustered. By changing the resonance frequency, beads are still pushed to a different nodes.

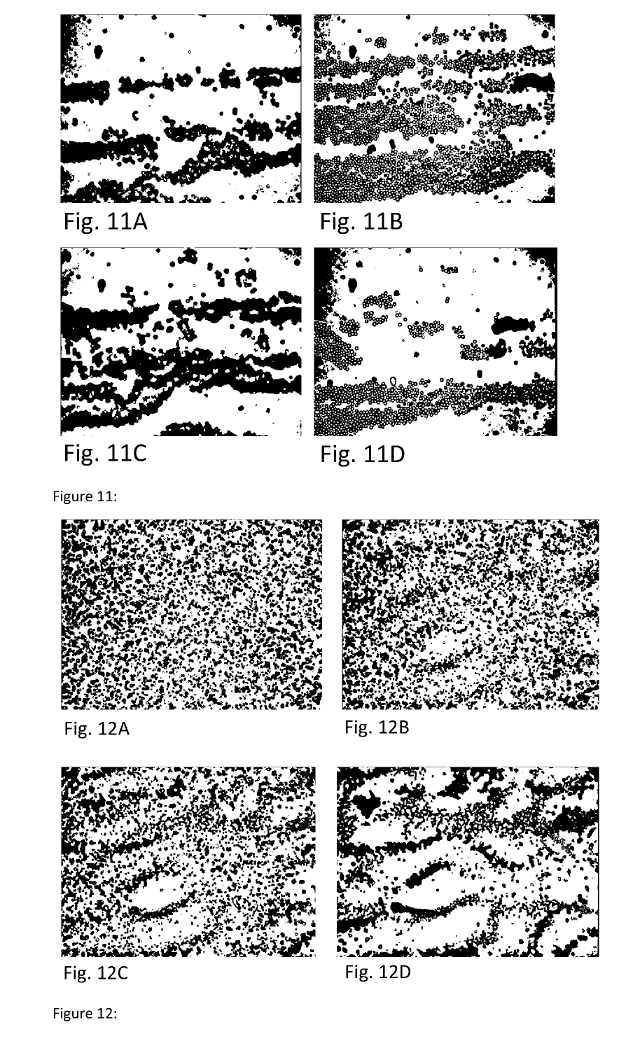

FIG. 11: Sweep frequency 1-30 MHz in 30 sec is used here. Typically frequencies can range from 1 kHz to 100 MHz. Different times can be used, such as 1 s, 10 s, 30 s or 80 s or 240 s. In these images you can observe all the acoustic effects that can be applied on the beads with our system: The waves are pushing the beads to different heights/node of the body. There can be a bead to bead attraction that is clustering of the beads. The longitudinal nodes are at certain frequencies very strong.

FIG. 12: With smaller 2.1 μm polystyrene beads it is observe that: The beads can still be pushed in a node. Bead are also clustering together T denotes the time steps following the application of the acoustic force.

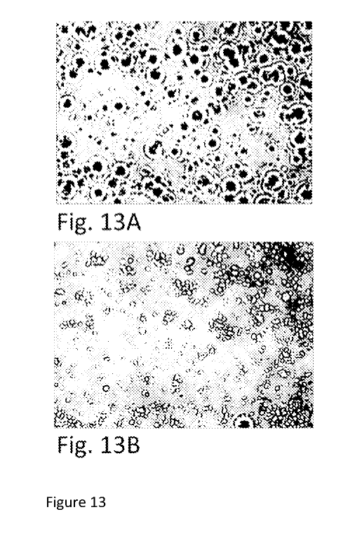

FIG. 13: Kaolin is pushed towards the node. (A) Force off. Kaolin diffuses over the whole flow cell when no force is applied. (B) Force on. When the force is turned on kaolin is pushed on the acoustic node (this can be seen from the diffraction pattern). Over time the Kaolin clusters together.

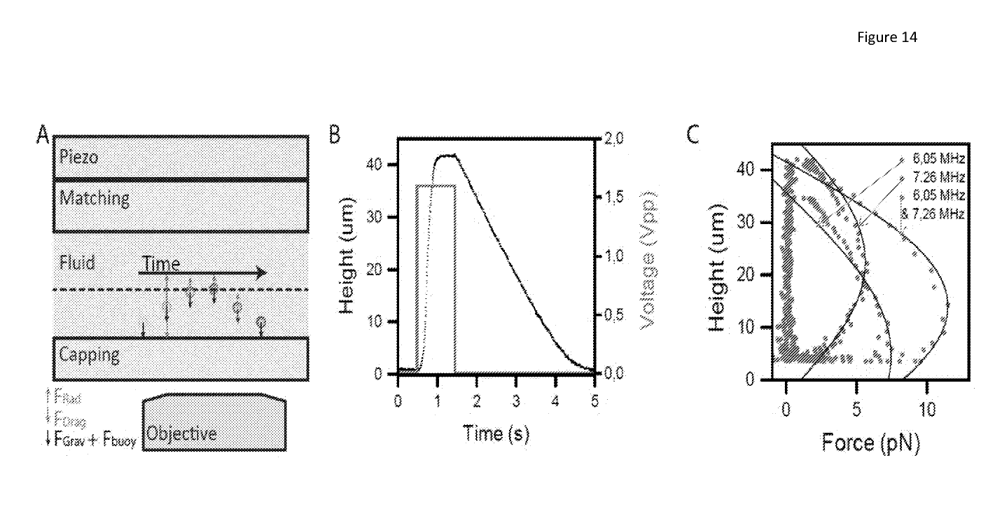

FIG. 14: The bead position was tracked when if is pushed from the surface to a node. From the velocity of the bead the acoustic force can be determined. This method was used to study the effect on the viscosity. (A) Push head form the surface to a node. (B) Track the bead displacement. (C) Convert that into a force profile.

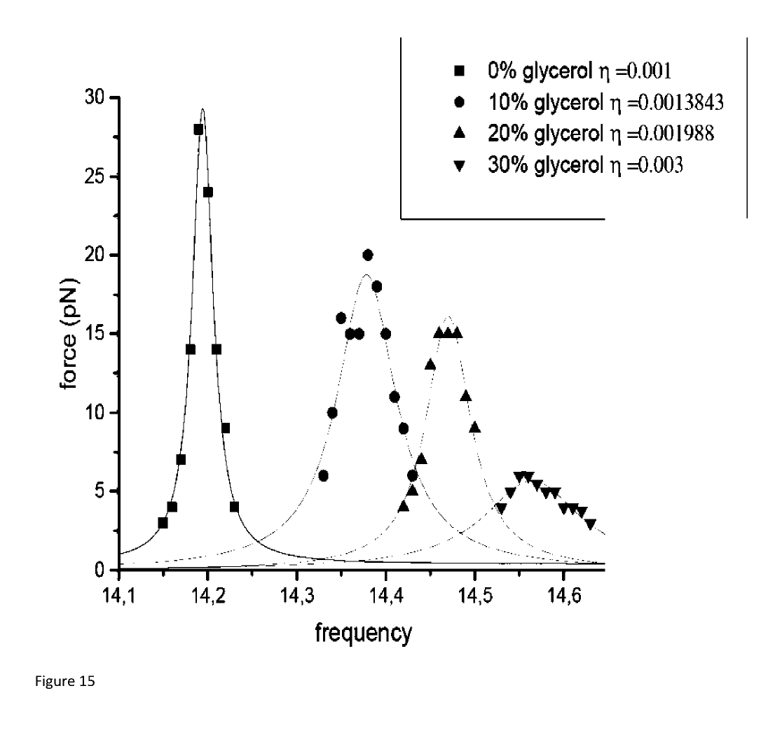

FIG. 15: Measured force response when viscosity is increased: 0, 10, 20 and 30% of glycerol was used to increase the viscosity and measure the effect on the force amplitude. The frequency is swept and fitted with a Lorentzian function. As can be seen from the fit: resonance is shifting upwards when the viscosity is increased, the width of the resonance is increased with increased viscosity and the force reduces with increasing viscosity. The viscosity also has an effect on the drag force. Pushing a bead in a node, the speed reduces because of the reduced acoustic force and the increased drag force.

1. A method for manufacturing a film comprising a particle structure fixated in a matrix material, the method comprising the steps of:
providing a mixture of a viscous matrix material and particles;
subjecting the particles to an acoustic standing wave, so as to arrange at least a portion of the particles in at least one of the group consisting of a pressure node and a pressure antinode of the acoustic standing wave thereby creating a particle structure in the viscous matrix; and
fixating the viscous matrix so as to fixate the particle structure in the matrix material.

2. The method of claim 1, further comprising the step of contacting the mixture with a first support and a second support.

3. The method of claim 2, wherein a pressure node is formed at an interface between the mixture and at least one of the group consisting of the first support and a pressure node is formed within the mixture.

4. The method of claim 2, wherein a pressure antinode is formed at an interface between the mixture and at least one of the group consisting of the first support and a pressure antinode is formed within the mixture.

5. The method of claim 2, further comprising a step of removal of at least one of the group consisting of the first support and the second support.

6. The method of claim 5, wherein the removal involves exposure of at least part of the particle structure.

7. The method of claim 1, wherein the body has the shape of a film with width: 0.01-100 m, thickness: 0.01-10 mm, length: 0.0001-100 km.

8. The method of claim 1, wherein the particles are selected from at least one of a group consisting of metal particles, air bubbles, oil droplets, polymer particles, carbonaceous particles, ceramic particles, bioactive particles, bacteria, viruses, archaea, fungi, sand particles, glass particles, and colloidal particles.

9. The method of claim 1, wherein the particles have substantially the same size.

10. The method of claim 1, wherein the viscous matrix material comprises or consists of a polymer.

11. The method of claim 1, wherein the viscous matrix is fixated by curing.

12. The method of claim 1, wherein the particle assemblies are further subjected to at least one of the group consisting of an electric field and a magnetic field.

13. The method of claim 1, wherein the method is used in combination with at least one of a group consisting of roll-to-roll processing, extrusion processes, 3D printing, electric and magnetic fields, optical trapping and manipulation, and printed electronics technology.

14. A body comprising a particle structure fixated in a matrix material, wherein the body is obtainable according to claim 1.

15. An article comprising or consisting of a body according to claim 13, the article being selected from at least one of a group consisting of packaging materials, printed electronics, laminated materials, textiles, paper, and containers.
